(19) United States
(12) Patent Application Publication
(10) Pub. No.: US 2016/0014284 A1
(43) Pub. Date: Jan. 14, 2016

(54) SYSTEM FOR VERIFYING PRINTED DOCUMENTS OF WEB PAGES

(71) Applicant: NAGOSOFT INC., Seoul (KR)

(72) Inventors: Jun Yong Ko, Anyang-si (KR); Nak Cheol Seong, Seoul (KR)

(21) Appl. No.: 14/741,646

(22) Filed: Jun. 17, 2015

(30) Foreign Application Priority Data
Jul. 10, 2014 (KR) 10-2014-0086659

(51) Int. Cl. H04N 1/00; G06F 21/36

(52) U.S. Cl. CPC H04N 1/00326; H04N 1/00864; G06F 21/36

(57) ABSTRACT

Provided is a system for verifying a printed document of a web page. In the system, when a user requests printing of a web page, a user personal computer (PC) generates a two-dimensional (2D) barcode from a verification identifier (ID) and an electronic (e)-signature, inserts the 2D barcode at an appropriate position in the web page whose size has been automatically adjusted. Therefore the 2D barcode included in the web page is not deformed and can be recognized in its entirety. And even when a 2D barcode is scanned by a smart phone, verification data is not directly exposed, and thus the confidentiality of the verification data is secured. Further, a verifier can not only determine whether or not a printed document of a web page is true, but also track a user PC that has output the printed document of the web page and a user thereof.

### CROSS-REFERENCE TO RELATED APPLICATION

This application claims priority to and the benefit of Korean Patent Application No. 2014-0086659, filed on Jul. 10, 2014, the disclosure of which is incorporated herein by reference in its entirety.

### BACKGROUND

1. Field of the Invention

The present invention relates to a system for verifying a printed document of a web page, and more particularly, to a system for verifying a printed document of a web page which verifies whether or not a printed document of a web page including a two-dimensional (2D) barcode, such as a quick response (QR) code, is true.

2. Discussion of Related Art

Recently, many technologies for providing an Internet certificate-issuing service are under development.

An existing Internet certificate-issuing system which provides the aforementioned Internet certificate-issuing service generally includes a user personal computer (PC) and a certificate issuing server. When a user requests the issuance of a certificate through a web browser of the user PC, the certificate issuing server transfers a certificate web page in which a 2D barcode including an electronic (e)-signature generated by applying a public key infrastructure (PKI) is inserted to the user PC, and the user PC displays the certificate web page in which the 2D barcode is inserted through a certificate viewer installed for the certificate issuing service. When the user requests printing of the certificate through the certificate viewer, the certificate web page is output as a printed document by a printer.

To determine whether or not a printed document of a copy of resident registration issued through such an existing Internet certificate-issuing system is true, a 2D barcode is generally scanned with a scanner to extract the content of the copy of the resident registration, a document check number, a page number, and an e-signature from the 2D barcode, and then the extracted e-signature is verified to check whether the extracted content of the copy of the resident registration, the extracted document check number, and the extracted page number are the same as content, a document check number, and a page number of a copy of the resident registration stored in a certificate issuing server.

In the above-described existing Internet certificate-issuing system, a certificate web page transferred to a user PC is not a general hypertext markup language (HTML) web page but a web page in which a 2D barcode has been inserted in advance by the certificate issuing server. Therefore, it is difficult to insert printing information, such as information on the user PC which prints the certificate web page, login information, and printer information, in the 2D barcode.

Meanwhile, in the most general method of printing a web page with a user PC, a basic printing function supported by a web browser is used. However, according to such a method, a web page is limitedly printed in the printing area of a vertical printing paper which is basically set in a web browser regardless of the size of the web page. Therefore, when the size of the web page is larger than the printing area of the printing paper of the web browser, the web page is printed on the printing paper with a specific area thereof, for example, a right edge portion of the web page, cut off, and as a result, the output printing paper is wasted.

For this reason, the present applicant (or inventor) developed “Method for printing web pages” disclosed in Patent Literature 4 as a solution to the problem of waste of a printing paper caused by the existing web page printing method. According to the web page printing method of Patent Literature 4, it is possible to scroll-capture a web page and print the web page whose size is automatically adjusted for the printing area of a web browser by executing a viewer for web page printing.

However, according to Patent Literature 4, when a certificate web page in which a 2D barcode has been inserted in advance is printed with a user PC like in the existing Internet certificate-issuing system, the size of a printing area is automatically adjusted, and thus the 2D barcode included in the certificate web page is reduced and deformed to be unrecognizable. Therefore, it is not possible to verify the printed document of the certificate.

Also, data inserted in a 2D barcode, such as an existing QR code, can be directly checked by a user of a smart phone with ease using a scanner program of the smart phone, and thus lacks security as confidential data.

### PRIOR ART

### Patent Literature

(Patent Literature 1) KR10-0455048 B1

(Patent Literature 2) KR10-0729600 B1

(Patent Literature 3) KR10-0508914 B1

(Patent Literature 4) KR10-0526109 B1

### SUMMARY OF THE INVENTION

The present invention is directed to a system for verifying a printed document of a web page in which, when a user requests printing of a web page, a user personal computer (PC) automatically adjusts the size of the web page according to a printing paper using a viewer for web page printing installed therein, generates a two-dimensional (2D) barcode from a verification identifier (ID) and an electronic (e)-signature received from a printed document authentication server immediately before outputting the web page as a printed document, inserts the 2D barcode at an appropriate position in the web page whose size has been automatically adjusted, and then outputs the web page as a printed document, and when a verifier requests verification of the output printed document of the web page, a verification terminal reads the 2D barcode from the printed document of the web page to confirm that the verification ID is valid, and then outputs verification data and printing information (e.g., user PC information, login information, and printer information) of the web page corresponding to the verification ID and received from the printed document authentication server such that the verifier sees the verification data and the printing information.

According to an aspect of the present invention, there is provided a system for verifying a printed document of a web page, the system including: a user PC having an installed viewer for web page printing capable of scroll-capturing a web page and printing the web page whose size has been automatically adjusted according to a printing area of a web browser, and configured to transfer a request for a web page requiring authentication of a user to a web server through the web browser, receive the web page additionally including verification data of the web page and a first e-signature for verifying the verification data from the web server, show the web page additionally including the verification data and the first e-signature on a screen of the web browser, and when the user requests printing of the web page additionally including the verification data and the first e-signature through the web browser, extract printing information by executing the viewer for web page printing, request a verification ID for verifying the web page and an e-signature for verifying the verification ID while transferring the verification data, the first e-signature, and the printing information to a printed document authentication server, generate a 2D barcode from the verification ID and a second e-signature for verifying the verification ID received from the printed document authentication server, automatically adjust a size of the web page according to a printing paper by executing the viewer for web page printing, insert the 2D barcode at an appropriate position in the web page whose size has been automatically adjusted immediately before outputting the web page as a printed document, and then output the web page as a printed document through a connected printer; the web server configured to transfer the verification data of the web page to the printed document authentication server when the web page request of the user PC is received, request an e-signature for verifying the verification data, add the verification data and the first e-signature to the web page when the first e-signature is received from the printed document authentication server, and then transfer the web page additionally including the verification data and the first e-signature to the user PC; the printed document authentication server configured to generate and transfer the first e-signature to the web server when the verification data is received from the web server and the e-signature is requested by the web server, generate and transfer the verification ID and the second e-signature to the user PC when the verification data, the first e-signature, and the printing information are received from the user PC and the verification ID and the e-signature for verifying the verification ID are requested by the user PC, store the verification data, the first e-signature, and the printing information all to correspond to the verification ID, receive the verification ID and the second e-signature read from the printed document of the web page requested for verification through a verification terminal, and transfer the previously stored verification data, first e-signature, and printing information corresponding to the verification ID to the verification terminal when the verification ID is verified; and the verification terminal configured to transfer the verification ID and the second e-signature read from the printed document of the web page requested for verification to the printed document authentication server, verify the verification data with the first e-signature when the verification data, the first e-signature, and the printing information corresponding to the verification ID are received from the printed document authentication server, and then output the verification data and the printing information of the web page such that a verifier sees the verification data and the printing information.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram showing a constitution of a system for verifying a printed document of a web page according to an exemplary embodiment of the present invention;

FIG. 2 shows an exemplary embodiment of a web page which requires authentication;

FIG. 3 shows an exemplary embodiment of a print preview screen showing a state in which a two-dimensional (2D) barcode is inserted at an appropriate position in the web page of FIG. 2 whose size has been automatically adjusted immediately before the web page is output as a printed document;

FIG. 4 shows an exemplary embodiment of a recognition screen of a 2D barcode inserted in a printed document of the web page of FIG. 2 output by a printer; and

FIG. 5 shows an exemplary embodiment of a verification result of the printed document of the web page shown in FIG. 4.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

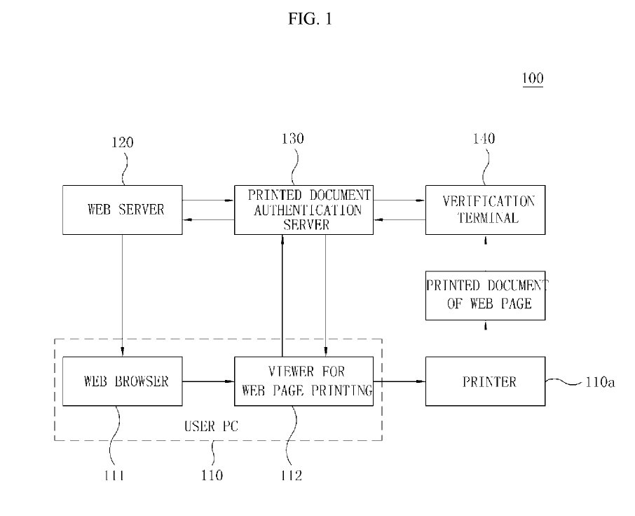

Referring to FIG. 1, a system 100 for verifying a printed document of a web page according to an exemplary embodiment of the present invention includes a user personal computer (PC) 110, a web server 120, a printed document authentication server 130, and a verification terminal 140.

As the verification terminal 140, a mobile communication device (e.g., a smart phone, a tablet PC, or a laptop computer), a PC, etc. may be used.

The user PC 110, the web server 120, the printed document authentication server 130, and the verification terminal 140 may communicate with each other through a wired and wireless information communication network (e.g., the wired Internet and the wireless Internet).

In the user PC 110, a viewer 112 for web page printing capable of scroll-capturing a web page and printing the web page whose size has been automatically adjusted according to a printing area of a web browser 111 is installed.

The user PC 110 transfers a request for a web page which requires authentication of a user (e.g., a variety of certificates) to the web server 120 through the web browser 111, receives the web page additionally including verification data of the web page and a first electronic (e)-signature for verifying the verification data from the web server 120, and shows the received web page on the screen of the web browser 111.

When a user requests printing of the web page additionally including the verification data and the first e-signature through the web browser 111, the user PC 110 executes the viewer 112 for web page printing to extract printing information (e.g., user PC information, login information, and printer information) and then requests a verification identifier (ID) for web page verification and an e-signature for verifying the verification ID while transferring the verification data, the first e-signature, and the printing information to the printed document authentication server 130.

The user PC 110 generates a 2D barcode from the verification ID and a second e-signature for verifying the verification ID received from the printed document authentication server 130, executes the viewer 112 for web page printing to automatically adjust the size of the web page according to a printing paper, inserts the 2D barcode at an appropriate position in the web page whose size has been automatically adjusted immediately before the web page is output as a printed document, and then outputs the web page as a printed document through a connected printer 110a.

When the web page request of the user PC 110 is received, the web server 120 transfers the verification data of the web page to the printed document authentication server 130, and requests an e-signature for verifying the verification data. After that, when the first e-signature is received from the printed document authentication server 130, the web server 120 adds the verification data and the first e-signature to the web page and transfers the resultant web page to the user PC 110.

When the verification data is received from the web server 120 and the e-signature is requested by the web server 120, the printed document authentication server 130 generates and transfers the first e-signature to the web server 120.

When the verification data, the first e-signature, and the printing information are received from the user PC 110 and the verification ID and an e-signature for verifying the verification ID are requested by the user PC 110, the printed document authentication server 130 generates and transfers the verification ID and the second e-signature to the user PC 110, and stores the verification data, the first e-signature, and the printing information all to correspond to the verification ID.

The printed document authentication server 130 receives the verification ID and the second e-signature read from the printed document of the web page (e.g., a variety of certificates) requested for verification through the verification terminal 140, and transfers the previously stored verification data, first e-signature, and printing information corresponding to the verification ID to the verification terminal 140 when the verification ID is verified.

The verification terminal 140 transfers the verification ID and the second e-signature read from the printed document of the web page (e.g., a variety of certificates) requested for verification to the printed document authentication server 130. After that, when the verification data, the first e-signature, and the printing information corresponding to the verification ID are received from the printed document authentication server 130, the verification terminal 140 verifies the verification data with the first e-signature, and then outputs the verification data and the printing information (e.g., user PC information, login information, and printer information) of the web page such that a verifier sees the verification data and the printing information.

The system 100 for verifying a printed document of a web page constituted as described above according to an exemplary embodiment of the present invention operates as follows.

The system 100 for verifying a printed document of a web page according to an exemplary embodiment of the present invention provides a user with a service of outputting a printed document of a web page requiring authentication (e.g., a variety of certificates).

An operation process in which the user communicates with the web server 120 or the printed document authentication server 130 using the user PC 110 to output a web page, which is desired by himself or herself and requires authentication, as a printed document through a printer is described below.

First, when the user requests a web page which requires authentication (e.g., a variety of certificates) through the web browser 111 of the user PC 110, the web server 120 transfers verification data of the web page to the printed document authentication server 130 and simultaneously requests an e-signature for verifying the verification data.

The printed document authentication server 130 generates a first e-signature for verifying the verification data and transfers the first e-signature to the web server 120.

When the first e-signature is received from the printed document authentication server 130, the web server 120 adds the verification data and the first e-signature to the web page and transfers the resultant web page to the user PC 110.

At this time, the web server 120 generates a meta-tag configured in the form of a pair of attributes “name:value” from the verification data and the first e-signature and adds the meta-tag to the web page.

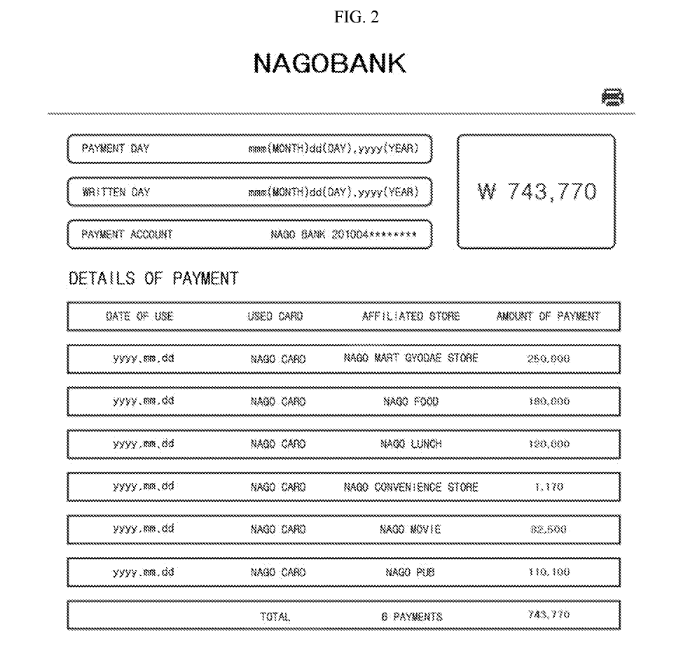

Table 1 below shows exemplary embodiments of meta-tags newly generated by the web server 120 to add the verification data (e.g., a customer name, a company name, a payment account, a payment day, a written day, the amount of payment, a customer class, a credit line, and a total) of the corresponding web page which is transferred to the printed document authentication server 130 by the web server 120 and the first e-signature which is generated to verify the verification data by the printed document authentication server 130 to the web page when a user requests a bank statement shown in FIG. 2 as a web page which requires authentication.

TABLE 1

<meta name=“PTMSEC_User” content=“customer name:Gildong Hong”></meta>
<meta name=“PTMSEC_Company” content=“company name:Daein Card”></meta>
<meta name=“PTMSEC_Serial” content=“payment account:Nago bank

2010042*****”></meta>

<meta name=“PTMSEC_PaymentDay” content=“payment day:mmm dd,

yyyy”></meta>

<meta name=“PTMSEC_WriteDay” content=“written day:mmm dd, yyyy”></meta>
<meta name=“PTMSEC_Payment” content=“amount of payment:743,770

won”></meta>

<meta name=“PTMSEC_VIP” content=“class:VIP”></meta>
<meta name=“PTMSEC_About” content=“credit line:1,000,000 won”></meta>
<meta name=“PTMSEC_Total” content=“total:10 payments”></meta>

<meta name=“PTMSEC_Signature” content=“e-signature:QR#ZGG#%FDQH$%”></meta>

In Table 1 above, a payment day and a written day are presented as “mmm(month) dd(day), yyyy(year)” for convenience.

When the web page additionally including the verification data and the first e-signature is received from the web server 120, the user PC 110 shows the web page on the screen of the web browser 111.

Subsequently, when the user requests printing of the web page additionally including the verification data and the first e-signature by pressing a print button through the web browser 111, the user PC 110 executes the viewer 112 for web page printing to verify the verification data with the first e-signature and confirms that the web page has not been forged, extracts printing information (e.g., user PC information, login information, and printer information), and then requests a verification ID for web page verification and an e-signature for verifying the verification ID while transferring the verification data, the first e-signature, and the printing information to the printed document authentication server 130.

At this time, the user PC 110 generates string information configured in the form of a pair of attributes “name:value” from the verification data, the first e-signature, and the printing information and transfers the string information to the printed document authentication server 130.

Table 2 below shows an exemplary embodiment of a printing information string which is generated by the user PC 110 executing the viewer 112 for web page printing, and Table 3 below shows an exemplary embodiment of a whole string of the verification data, the first e-signature, and the printing information which is generated by the user PC 110 executing the viewer 112 for web page printing.

TABLE 2
computemame:kwg-PC|computerIP:192.168.1.11|useraccount:user1234|
print:HP2024

TABLE 3
companyname:Daeincard|paymentaccount:Nagobank2010042*****|paymentday:
mmmdd,yyyy|writtenday:mmmdd,yyyy|amountofpayment:743,770won|class: VIP|
creditline:1,000,000won|total:10payments|e-signature:QR#ZGG#%FDQH$%|
computername:kwg-PC|computerIP:192.168.1.11|useraccount:user1234|
print:HP2024

In Table 3 above, a payment day and a written day are presented as “mmm(month) dd(day), yyyy(year)” for convenience.

As described above, when the verification data, the first e-signature, and the printing information are received from the user PC 110 and the verification ID and an e-signature for verifying the verification ID are requested by the user PC 110, the printed document authentication server 130 verifies the verification data with the first e-signature to confirm that the verification data has not been forged, generates the verification ID and a second e-signature for verifying the verification ID, transfers the verification ID and the second e-signature to the user PC 110, and stores the verification data, the first e-signature, and the printing information all to correspond to the verification ID.

Subsequently, the user PC 110 generates a 2D barcode from the verification ID and the second e-signature for verifying the verification ID received from the printed document authentication server 130, executes the viewer 112 for web page printing to automatically adjust the size of the web page according to a printing paper, inserts the 2D barcode at an appropriate position in the web page whose size has been automatically adjusted immediately before outputting the web page as a printed document, and then outputs the resultant web page as a printed document through the connected printer 110a.

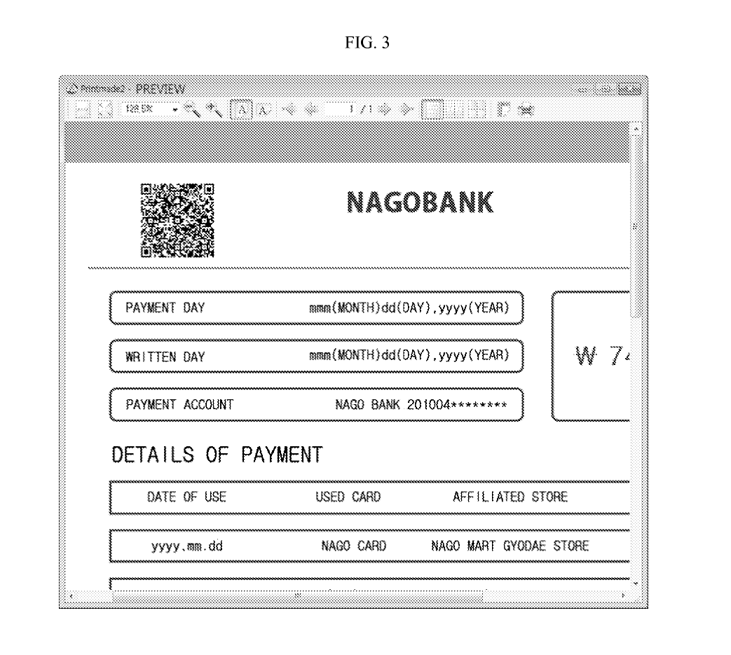

For reference, FIG. 3 shows a state in which a 2D barcode is inserted at an appropriate position in the web page of FIG. 2 whose size has been automatically adjusted immediately before the web page is output as a printed document.

As described above, when the user PC 110 executes the viewer 112 for web page printing to automatically adjust the size of the web page according to the printing paper, inserts the 2D barcode at the appropriate position in the web page whose size has been automatically adjusted immediately before outputting the web page as a printed document, and then outputs the resultant web page as a printed document through the connected printer 110a, the 2D barcode in the form of an image included in the web page is not deformed and is output in its entirety, and thus it is possible to identify the 2D barcode upon scanning the 2D barcode.

After the web page requiring authentication (e.g., a variety of certificates) is output as a printed document, the printed document of the web page (e.g., a variety of certificates) is verified by a verifier.

The system 100 for verifying a printed document of a web page according to an exemplary embodiment of the present invention provides the verifier with a service of verifying a printed document of a web page requiring authentication (e.g., a variety of certificates).

An operation process in which the verifier communicates with the printed document authentication server 130 using the verification terminal 140 to verify whether or not a printed document of a web page requiring authentication is true is described below.

The verification terminal 140 scans the 2D barcode included in the printed document of the web page of which verification has been requested to read the verification ID and the second e-signature, and transfers the verification ID and the second e-signature to the printed document authentication server 130.

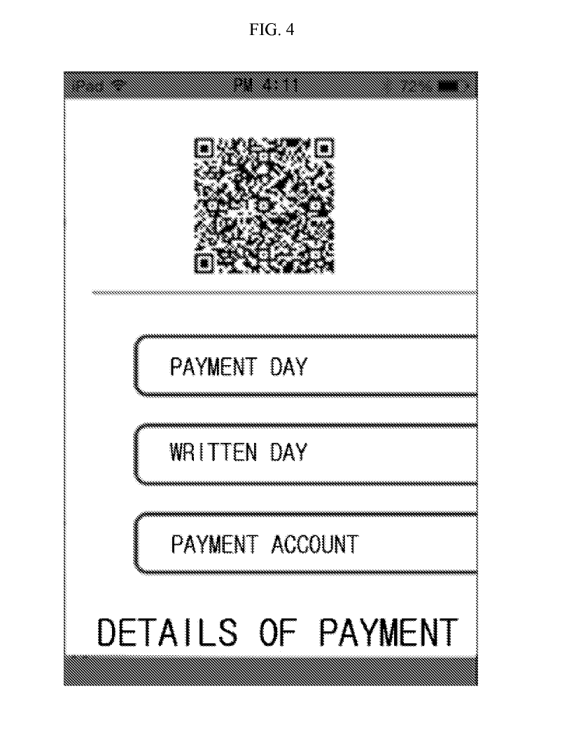

For reference, FIG. 4 shows a screen of recognizing a 2D barcode inserted in a printed document of the web page of FIG. 2 output by a printer using a scanner program of iPad which is a tablet computer.

The printed document authentication server 130 verifies the verification ID received from the verification terminal 140 with the second e-signature to confirm that the verification ID has not been forged, and then transfers the previously stored verification data, first e-signature, and printing information (e.g., user PC information, login information, and printer information) corresponding to the verification ID to the verification terminal 140.

Subsequently, the verification terminal 140 verifies the received verification data with the first e-signature to confirm that the verification data has not been forged, and then outputs the verification data and the printing information (e.g., user PC information, login information, and printer information) of the web page on a screen such that the verifier may see the verification data and the printing information.

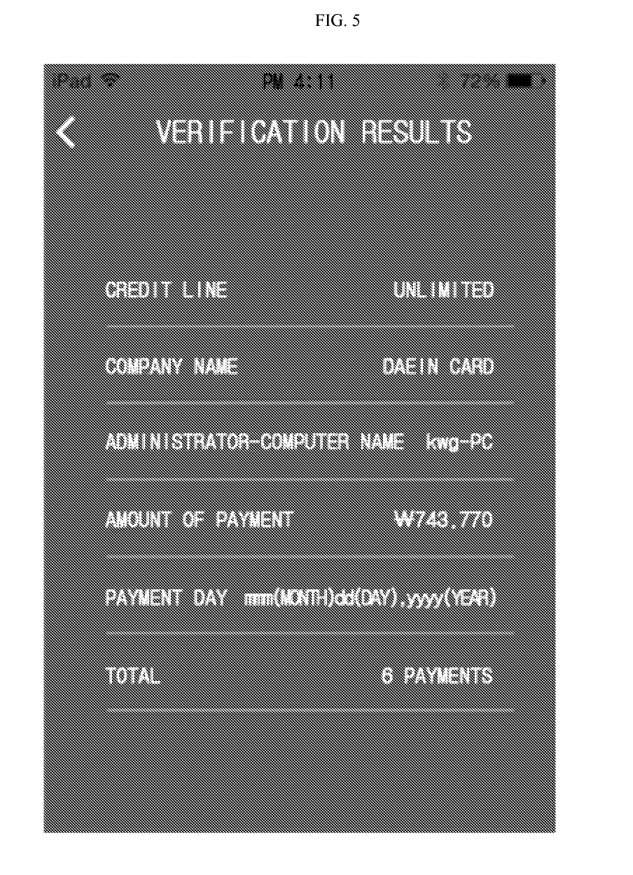

For reference, FIG. 5 shows a verification result of the printed document of the web page shown in FIG. 4.

Accordingly, the verifier compares content of the printed document of the web page provided by a user with the verification data output on the screen of the verification terminal 140, thereby verifying whether the web page requiring authentication is true or not or has been forged or not.

Also, by checking the printing information (e.g., user PC information, login information, and printer information) output on the screen of the verification terminal 140, the verifier may track the user PC 110 that has output the web page as the printed document and the user thereof

Further, a 2D barcode according to exemplary embodiments of the present invention includes a verification ID. Therefore, even when the 2D barcode is scanned by a smart phone, verification data is not directly exposed, and the confidentiality of the verification data is maintained.

As described above, in exemplary embodiments of the present invention, a 2D barcode is inserted in a web page immediately before the web page is output as a printed document, and then the web page is output as a printed document. Therefore, even when the size of a printing area of the web page is automatically adjusted, the 2D barcode included in the web page is not deformed and can be recognized in its entirety. Also, even when the 2D barcode is scanned by a smart phone, verification data is not directly exposed, and thus the confidentiality of the verification data is secured. Further, a verifier can not only determine whether or not the printed document of the web page is true, but also track a user PC that has output the printed document of the web page and a user thereof.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A system for verifying a printed document of a web page, the system comprising:
a user personal computer (PC) having an installed viewer for web page printing capable of scroll-capturing a web page and printing the web page whose size has been automatically adjusted according to a printing area of a web browser, and configured to transfer a request for a web page requiring authentication of a user to a web server through the web browser, receive the web page additionally including verification data of the web page and a first e-signature for verifying the verification data from the web server, show the web page additionally including the verification data and the first e-signature on a screen of the web browser, and when the user requests printing of the web page additionally including the verification data and the first e-signature through the web browser, extract printing information by executing the viewer for web page printing, request a verification identifier (ID) for verifying the web page and an e-signature for verifying the verification ID while transferring the verification data, the first e-signature, and the printing information to a printed document authentication server, generate a two-dimensional (2D) barcode from the verification ID and a second e-signature for verifying the verification ID received from the printed document authentication server, automatically adjust a size of the web page according to a printing paper by executing the viewer for web page printing, insert the 2D barcode at an appropriate position in the web page whose size has been automatically adjusted immediately before outputting the web page as a printed document, and then output the web page as a printed document through a connected printer;
the web server configured to transfer the verification data of the web page to the printed document authentication server when the web page request of the user PC is received, request an e-signature for verifying the verification data, add the verification data and the first e-signature to the web page when the first e-signature is received from the printed document authentication server, and then transfer the web page additionally including the verification data and the first e-signature to the user PC;
the printed document authentication server configured to generate and transfer the first e-signature to the web server when the verification data is received from the web server and the e-signature is requested by the web server, generate and transfer the verification ID and the second e-signature to the user PC when the verification data, the first e-signature, and the printing information are received from the user PC and the verification ID and the e-signature for verifying the verification ID are requested by the user PC, store the verification data, the first e-signature, and the printing information all to correspond to the verification ID, receive the verification ID and the second e-signature read from the printed document of the web page requested for verification through a verification terminal, and transfer the previously stored verification data, first e-signature, and printing information corresponding to the verification ID to the verification terminal when the verification ID is verified; and
the verification terminal configured to transfer the verification ID and the second e-signature read from the printed document of the web page requested for verification to the printed document authentication server, verify the verification data with the first e-signature when the verification data, the first e-signature, and the printing information corresponding to the verification ID are received from the printed document authentication server, and then output the verification data and the printing information of the web page such that a verifier sees the verification data and the printing information.

2. The system of claim 1, wherein the web server generates a meta-tag configured in a form of a pair of attributes “name:value” from the verification data and the first e-signature, adds the meta-tag to the web page, and transfers the web page to the user PC.

3. The system of claim 1, wherein the user PC generates string information configured in a form of a pair of attributes “name:value” from the verification data, the first e-signature, and the printing information, and transfers the string information to the printed document authentication server.
